(19) United States
(12) Patent Application Publication
(10) Pub. No.: US 2021/0131201 A1
(43) Pub. Date: May 6, 2021

(54) OIL SWELLABLE MATERIAL FOR LOW TEMPERATURE LOST CIRCULATION MATERIAL APPLICATION

(71) Applicant: Halliburton Energy Services, Inc., Houston, TX (US)

(72) Inventors: Sunita Sameer Kadam, Pune (IN); Akashdeep Singh Jamwal, Jammu (IN); V Ramireddy Devarapalli, Pune (IN)

(73) Assignee: Halliburton Energy Services, Inc., Houston, TX (US)

(21) Appl. No.: 16/672,118

(22) Filed: Nov. 1, 2019

(51) Int. Cl. E21B 21/00; C09K 8/502; C09K 8/508; C09K 8/44

(52) U.S. Cl. CPC E21B 21/003; C09K 8/502; C09K 2208/18; C09K 8/44; C09K 8/5086

(57) ABSTRACT

A method for bridging a lost circulation zone comprising: providing a lost circulation composition comprising a phosphate ester based lost circulation material and a carrier fluid; introducing the lost circulation composition into a wellbore within a subterranean formation, wherein the subterranean formation comprises a lost circulation zone; and placing the lost circulation composition into the lost circulation zone.

### BACKGROUND

A natural resource such as oil or gas residing in a subterranean formation can be recovered by drilling a well bore into the formation. A wellbore is typically drilled while circulating a drilling fluid through the wellbore. Among other things, the circulating drilling fluid may lubricate the drill bit, carry drill cuttings to the surface, and balance the formation pressure exerted on the well bore. One problem associated with drilling may be the undesirable loss of drilling fluid to the formation. Such lost fluids typically flow from the wellbore into fractures in the subterranean formation such as fractures induced by excessive mud pressures or into pre-existing open fractures. Loss of fluid to a formation may be referred to as “lost circulation,” and the sections of the formation into which the drilling fluid may be lost may be referred to as “lost circulation zones.” The loss of drilling fluid into the formation is generally undesirable, inter alia, because of the expense associated with the drilling fluid lost into the formation and potential loss of productivity during remedial operations. Drilling fluid provides hydrostatic pressure on wellbore walls which aids in stabilizing the wellbore and ensures that formation fluids are contained during drilling. Lost circulation therefore may be a factor associated with problems with well control and borehole instability. Further the loss of hydrostatic pressure balancing may cause pipe sticking where a drill pipe is stuck to a borehole wall through differential pressure and unsuccessful production tests. Drilling fluid invasion to producing formations may result poor hydrocarbon production after well completion and formation damage due to plugging of pores and pore throats by mud particles.

One method that has been developed to control lost circulation involves the placement of lost circulation materials into the lost circulation zone. Lost circulation materials may physically block the fractures present in the lost circulation zone, thereby reducing permeability of fluids into, and out of, the lost circulation zone. Some examples of lost circulation materials may include water swellable polymers and particulate materials which may be screened for particle size. Water swellable polymers may require a minimum temperature to become hydrated to perform as lost circulation materials. For these and of other reasons, use of water swellable lost circulation materials may not provide a desirable level of lost circulation control. Water swellable polymeric materials typically do not swell in oil base carrier fluids which may limit their use.

### BRIEF DESCRIPTION OF THE DRAWINGS

These drawings illustrate certain aspects of some of the embodiments of the present disclosure, and should not be used to limit or define the disclosure.

FIG. 1 illustrates an embodiment of the introduction of a lost circulation compositions into a lost circulation zone within a wellbore penetrating a subterranean formation.

FIG. 2 illustrates another embodiment of the introduction of a lost circulation compositions into a lost circulation zone within a wellbore penetrating a subterranean formation.

FIG. 3 illustrates a system for the preparation and delivery of a lost circulation composition into a wellbore in accordance with certain embodiments.

FIG. 4 is photograph of an example dried reaction product.

FIG. 5 is a photograph of an example swelled reaction product in base oil

FIG. 6a is a photograph of an example dried reaction product before dispersion in an oil-based drilling fluid.

FIG. 6b is a photograph of an example swelled product after dispersion into an oil-based drilling fluid.

FIG. 7a is a photograph of an example drilling fluid containing a mixture of phosphate ester surfactant and ferric sulfate in an oil-based drilling fluid.

FIG. 7b is a photograph of an example drilling fluid containing a phosphate ester based lost circulation material.

FIG. 8a is a photograph showing results of an example particle plugging test.

FIG. 8b is a photograph showing results of an example particle plugging test.

FIG. 9a is a photograph showing an example of unmodified graphitic carbon in a beaker containing base oil.

FIG. 9b is a photograph of an example hybrid lost circulation material showing swelling in base oil.

FIG. 9c is a photograph of an example hybrid lost circulation material showing swelling.

FIG. 10a is a photograph showing results of an example particle plugging test.

FIG. 10b is a photograph showing results of an example particle plugging test.

FIG. 10c is a photograph showing results of an example particle plugging test.

FIG. 10d is a photograph showing results of an example particle plugging test.

### DETAILED DESCRIPTION

The disclosed examples relate to servicing a wellbore and, in particular, to the introduction of an oil-swellable lost circulation materials into a wellbore to reduce the loss of fluid into a subterranean formation. There may be several potential advantages to the disclosed methods and compositions, only some of which may be alluded to herein. One of the many potential advantages of the methods and compositions is that the lost-circulation materials may be oil swellable. Lost circulation materials that swell in the presence of oil may provide greater lost circulation performance over lost circulation materials that swell in water in some applications. Another potential advantage of the disclosed lost circulation materials is that the lost circulation materials may be used at lower temperatures than some water swellable polymers.

Lost circulation materials disclosed herein may include a reaction product of a phosphate ester surfactant and a crosslinker, herein referred to as a phosphate ester based lost circulation material. Phosphate ester based lost circulation materials may have properties desirable for controlling lost circulation such as the ability to swell in the presence of hydrocarbon oils. One method of making the phosphate ester based lost circulation material may include reacting a phosphate ester surfactant and crosslinker to form phosphate ester based loss circulation material. The phosphate ester based lost circulation material may be added to a carrier fluid and then used in a variety of lost circulation material compositions. Further, the phosphate ester based lost circulation material may be mixed with other types of lost circulation materials. Phosphate ester based lost circulation materials may be oil swellable which may allow the phosphate ester based lost circulation material to swell in oil based fluids such as invert emulsion drilling fluids.

Phosphate ester based lost circulation materials may include reaction products of phosphate ester surfactants and a crosslinker. Phosphate esters may be derived from reaction of esters with phosphoric acid, for example. Phosphate ester surfactants may include phosphate esters such as those depicted in Formula 1 and Formula 2. Formula 1 depicts a generalized structure of a phosphate mono-ester and Formula 2 depicts a generalized structure of a phosphate di-ester. The R group in Formula 1 and Formula 2 may be individually selected from the group consisting of alcohol, ethoxylated alcohol, ethoxylated phenol, and combinations thereof. The R group may have any carbon chain length suitable for a particular application, including carbon numbers from about C4 to about C20. Alternatively, the R group may have a carbon number of about C4 to about C8, from about C8 to about C12, from about C12 to about C16, from about C16 to about C20, or any ranges therebetween. Further, the R group may be linear or have any degree of branching desired for a particular application. Formula 2 has two R groups each of which may be individually selected to be the same R group or different R group.

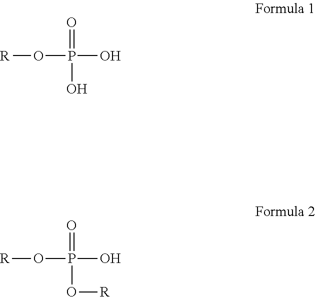

Crosslinkers may be reacted with the phosphate esters to produce the phosphate ester based lost circulation material. Suitable crosslinkers may include any crosslinkers capable of crosslinking the phosphate ester to produce the phosphate ester based lost circulation material such as those containing iron, for example. Crosslinkers may include salts of iron compounds, hydrates of iron compounds, and complexes of iron compounds. Some suitable crosslinkers may include, without limitation, the iron containing crosslinkers listed in Table 1.

TABLE 1

| Species | Formula |
|---|---|
| Ammonium iron(II) sulfate hexahydrate | (NH₄)₂Fe(SO₄)₂ 6H₂O |
| Iron(II) bromide | FeBr₂ |
| Iron(III) bromide | FeBr₃ |
| Iron(II) chloride | FeCl₂ |
| Iron(II) chloride tetrahydrate | FeCl₂ 4H₂O |
| Iron(III) chloride | FeCl₃ |
| Iron(III) citrate | C₆H₅FeO₇ |
| Iron(II) fluoride | FeF₂ |
| Iron(III) fluoride | FeF₃ |
| Iron(III) fluoride trihydrate | FeF₃ 3H₂O |
| Iron(II) iodide | FeI₂ |
| Iron(III) nitrate nonahydrate | Fe(NO₃)₃ 9H₂O |
| Iron(II) oxalate dihydrate | FeC₂O₄ 2H₂O |
| Iron(III) oxalate hexahydrate | Fe₂(C₂O₄)₃•6H₂O |
| Iron(II) perchlorate hydrate | Fe(ClO₄)₂•xH₂O |
| Iron(III) phosphate tetrahydrate | FePO₄ 4H₂O |
| Iron(III) pyrophosphate | Fe₄(P₂O₇)₃ |
| Iron(II) sulfate | Fe₂(SO₄)₃ |
| Iron(II) sulfate hydrate | FeSO₄•xH₂O |
| Iron(II) tetrafluoroborate hexahydrate | Fe(BF₄)₂•6H₂O |
| Potassium hexacyanoferrate(II) trihydrate | K₄Fe(CN)₆ 3H₂O |

The phosphate ester based lost circulation material may be prepared by any suitable reaction scheme. In some examples, the phosphate ester surfactants and a crosslinker may be combined in a reactor and allowed to react to form the phosphate ester based lost circulation material. The phosphate ester surfactants and a crosslinker may be combined in any suitable ratio including from about 1:0.5 to about 1:10 crosslinker to phosphate ester by weight. Alternatively, the crosslinker to phosphate ester weight ratio may be from about 1:0.5 to about 1:1, about 1:1 to about 1:5, about 1:5 to about 1:10, or any range therebetween. The crosslinker to phosphate ester ratio may be adjusted to provide relatively more or less crosslinking which may affect the physical properties of the resultant phosphate ester list circulation material.

The phosphate ester based lost circulation material may have any particle size suitable for a particular application including from a Dv50 particle size between about 0.01 microns to about 100 microns. Alternatively, phosphate ester based lost circulation material may have a Dv50 particle size from about 0.01 micron to about 100 microns, about 0.1 micron to about 20 microns, about 20 microns to about 40 microns, about 40 microns to about 60 microns, about 60 microns to about 80 microns, about 80 microns to about 100 microns, about 1 micron to about 50 microns, or about 50 microns to about 100 microns. The Dv50 particle size may also be referred to as the median particle size by volume of a particulate material. The Dv50 particle size is defined as the maximum particle diameter below which 50% of the material volume exists. The Dv50 particle size values for a particular sample may be measured by commercially available particle size analyzers such as those manufactured by Malvern Instruments, Worcestershire, United Kingdom. The selected particle size may depend on the desired application and the specifics of the wellbore.

Generally, the treatment fluids disclosed herein may include a phosphate ester based lost circulation material and a base fluid. In some examples, the base fluid may be a treatment fluid used for servicing a wellbore, such as a cement, a drilling fluid, a spacer fluid, or a spotting fluid, for example. The phosphate ester based lost circulation material may be included in the treatment fluid to inter alia provide lost circulation mitigation during a wellbore operation. The phosphate ester based lost circulation material may be dispersed in a carrier fluid to produce lost circulation compositions. The carrier fluid may be a non-aqueous carrier fluid or may be saltwater (e.g., water containing one or more salts dissolved therein, seawater, brines, saturated saltwater, etc.). Examples of non-aqueous carrier fluids may include any non-aqueous carrier fluid suitable for use in a wellbore. Without limitation, specific examples of carrier fluids include petroleum oil, natural oil, synthetically derived oil, mineral oil, silicone oil, kerosene oil, diesel oil, an alpha olefin, an internal olefin, an ester, a diester of carbonic acid, a paraffin, or combinations thereof. In general, the carrier fluid may be present in an amount sufficient to form a pumpable fluid. By way of example, the carrier fluid may be present in in an amount in the range of from about 50% to about 80% by weight of the lost circulation composition. In an embodiment, the carrier fluid may be present in an amount of about 60% to about 75% by weight of the lost circulation composition.

Lost circulation materials in addition to the above described phosphate ester based lost circulation material may be included in the lost circulation compositions to, for example, help prevent the loss of fluid circulation into the subterranean formation. Examples of additional lost-circulation materials that may be used include, but are not limited to, cedar bark, shredded cane stalks, mineral fiber, mica flakes, cellophane, calcium carbonate, ground rubber, polymeric materials, pieces of plastic, grounded marble, wood, nut hulls, plastic laminates, corncobs, and cotton hulls. The additional lost circulation material or materials may be blended with the phosphate ester based lost circulation material prior to combination of the blend with the carrier fluid to form the lost circulation composition.

In some embodiments, the lost circulation compositions may further comprise a viscosifier to, for example, aid in suspending any of the lost circulation materials in the lost circulation compositions. Suitable viscosifying agents may include, but are not limited to, colloidal agents (e.g., clays such as bentonite, polymers, and guar gum), emulsion-forming agents, diatomaceous earth, biopolymers, synthetic polymers, chitosans, starches, gelatins, or mixtures thereof. The clay may include a colloidal clay, nano clay, a synthetic clay, or a combination thereof. The viscosifier may be present in the lost circulation composition in an amount of about 0.1% to about 2% by weight of the lost circulation composition. For example, the viscosifier may be present in an amount of about 0.1%, about 0.5%, about 1%, or about 2% by weight of the lost circulation composition.

Breakers may be included with the phosphate ester based lost circulation material to break the ionic bonds formed between the iron and phosphate in the phosphate ester based lost circulation material. Breaking the ionic bonds may reduce the viscosity of fluid containing the phosphate ester based lost circulation material thereby allowing the lost circulation material to be removed. Some exemplary breakers may include, without limitation, group (II) metal oxides such as magnesium oxide and calcium oxide as well as organic compounds such as quaternary amines and amides which may include urea, for example.

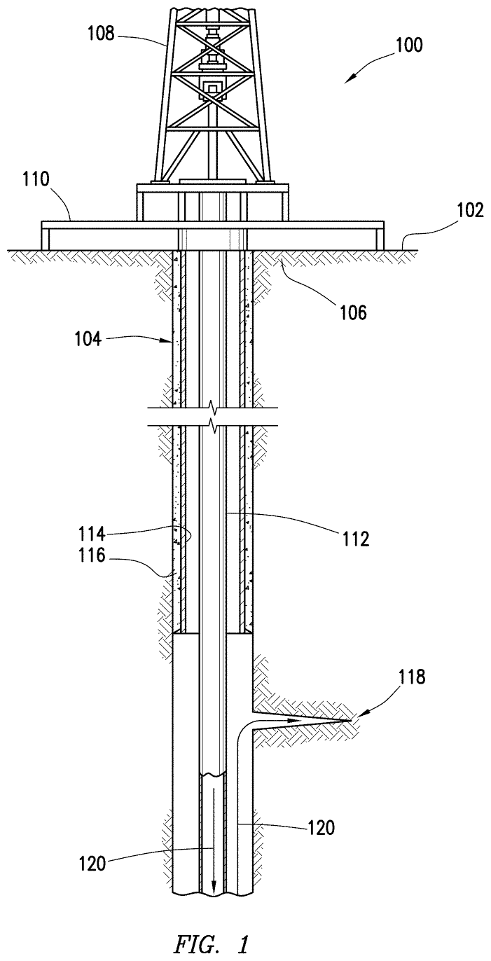

A system for bridging a lost circulation zone may be provided. The system may include one or all of the components illustrated on FIGS. 1-3. The system may comprise a lost circulation composition comprising phosphate ester based lost circulation material and a carrier fluid; mixing equipment capable of mixing the phosphate ester based lost circulation material and the carrier fluid; and pumping equipment capable of introducing the lost circulation composition into the lost circulation zone. The phosphate ester based lost circulation material may be a reaction product of a phosphate ester surfactant and a crosslinker as disclosed above.

Turning now to FIG. 1, an example operating environment for the methods and compositions described herein is shown. It should be noted that while FIG. 1 generally depicts a land-based operation, those skilled in the art should readily recognize that the principles described herein are equally applicable to subsea operations that employ floating or sea-based platforms and rigs, without departing from the scope of the disclosure. As illustrated, a drilling rig 100 may be positioned on the Earth's surface 102 extending over and around a wellbore 104 that penetrates a subterranean formation 106. While the wellbore 104 is shown extending generally vertically into the subterranean formation 106, the principles described herein are also applicable to wellbores that extend at an angle through the subterranean formation 106, such as horizontal and slanted wellbores. The wellbore 104 may be drilled into the subterranean formation 106 using any suitable drilling technique. In an embodiment, the drilling rig 100 comprises a derrick 108 with a rig floor 110 through which a work string 112 extends downward from the drilling rig 100 into the wellbore 104. Work string 112 may be any such string, casing, or tubular through which a fluid may flow. While not shown, the work string 112 may a deliver a wellbore servicing apparatus (e.g., a drill bit) or some part thereof to a predetermined depth within the wellbore 104. In some embodiments, at least a portion of the wellbore 104 may be lined with a casing 114 that may be secured into position in the wellbore 104 using cement 116. In alternative embodiments, the wellbore 104 may be partially cased and cemented thereby resulting in a portion of the wellbore 104 being openhole.

During any one or more wellbore drilling, completion, or servicing operations, a lost circulation zone 118 may be encountered. Where the lost circulation zone 118 is encountered, it may be desirable to employ the lost circulation compositions disclosed herein to prevent, lessen, minimize, and/or cease the loss of fluids to the lost circulation zone 118. Placement of a lost circulation composition into the lost circulation zone 118 may be an effective means of plugging or sealing off the lost circulation zone 118 and thereby preventing, ceasing, and/or substantially lessening the loss of fluids from the wellbore 104 to the lost circulation zone 118. While the lost circulation zone 118 is shown as an opening that extends from the wellbore 104 into the subterranean formation 106, it is contemplated that the lost circulation zone 118 may contain one or more features including, without limitation, fractures (natural or pre-existing), cracks, vugs, channels, openings, and/or the like. Moreover, while the lost circulation zone 118 is illustrated in an openhole section of the wellbore 104, it is contemplated that a lost circulation zone may also occur in a section of the wellbore 104 with the casing 114.

As discussed, lost circulation zone 118 may be bridged with the lost circulation compositions described herein. The lost circulation compositions may be provided in a weighted or unweighted “pill” as represented by arrow 120 for introduction into the wellbore. Such pills typically comprise the lost circulation materials, including the phosphate ester based lost circulation material, blended with an amount of carrier fluid. The amount of the lost circulation materials used in the pill will depend on the size of the lost circulation zone 118 to be treated. Multiple pills or treatments may be used if needed. Drilling may be stopped while the pill is introduced into and circulated in the wellbore 104. As illustrated in FIG. 1, the pill, as represented by arrow 120, may be pumped into wellbore 104 via work string 112, which exits below lost circulation zone 118. The pill 120 may be pumped up the wellbore annulus where it may enter lost circulation zone 118. Once spotted into place, the pill 120 may prevent or retard the entry of drilling or other wellbore fluids. Pressure may be used to squeeze the pill into the lost circulation zone 118. Alternatively, a lost circulation composition may be added to the drilling fluid and circulated with the drilling fluid during drilling or servicing of the well. The phosphate ester based lost circulation material within the pill 120 may swell after contact with oil in the wellbore or drilling fluid placed in the wellbore. The swelling may enhance the ability of the pill 120 to prevent, cease, and/or substantially lessen the loss of fluids from the wellbore 104 to the lost circulation zone 118. If it is desirable to remove at least a portion of the pill 120, for example, if the pill 120 is interfering with a producing zone, the pill 120 may be exposed to a breaker. as described above. Once exposed, at least a portion of the pill 120 may dissolve.

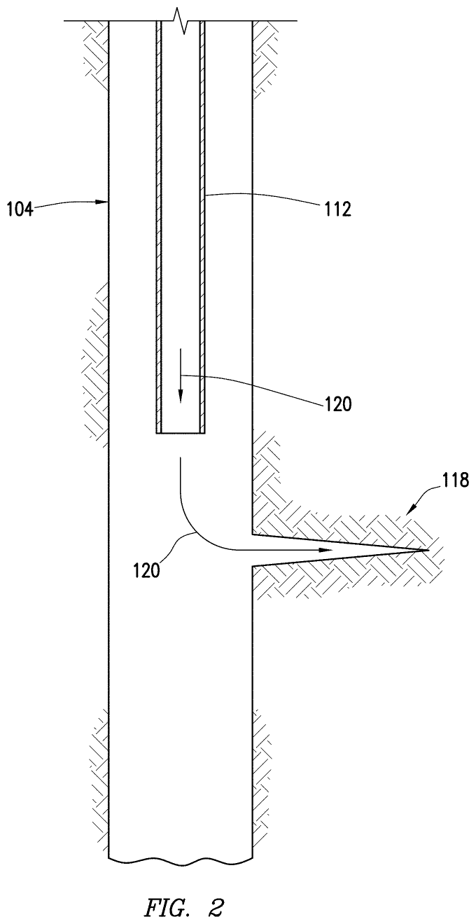

Turning now to FIG. 2, the lost circulation compositions may be placed in the lost circulation zone 118 by work string 112, which for this example, exits above lost circulation zone 118. Optionally a plug, not shown, may be placed below the lost circulation zone 118. The pill, represented by arrow 120, may be pumped into a portion of the wellbore 114 near, proximate to, or within the lost circulation zone 118. At least a portion of the pill 120 may enter into the lost circulation zone 118 to prevent, cease, and/or substantially lessen the loss of fluids from the wellbore 104 to the lost circulation zone 118. In some alternative examples, the pill 120 may be pumped through a drill bit, not shown, however care should be used with this process so that the pill 120 does not block openings in the drill bit. The phosphate ester based lost circulation material within the pill 120 may swell after contact with oil in the wellbore or oil placed in the wellbore from a drilling fluid or carrier fluid. The swelling may enhance the ability of the pill 120 to prevent, cease, and/or substantially lessen the loss of fluids from the wellbore 104 to the lost circulation zone 118. If it is desirable to remove at least a portion of the pill 120, for example, if the pill is interfering with a producing zone, the pill 120 may be exposed to breaker such as metal oxides such as magnesium oxide or urea as described above. Once exposed, at least a portion of the pill 120 may dissolve and be removed.

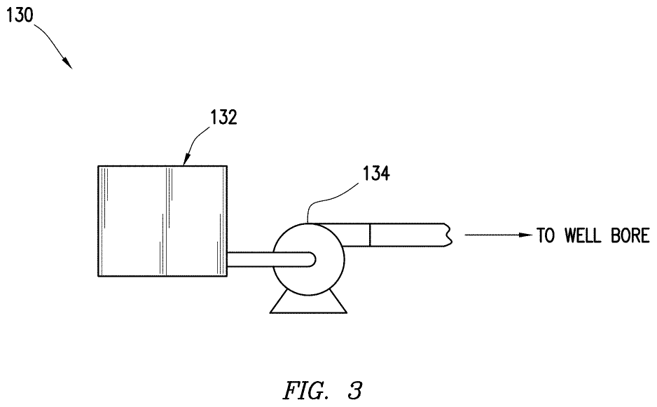

Turning now to FIG. 3, a system 130 is illustrated that may be used in placement of a lost circulation composition or particular portion thereof into a wellbore 118 in accordance with some of the examples described herein. As shown, the lost circulation composition (or a portion thereof) may be mixed in mixing equipment 132, such as a hopper, jet mixer, re-circulating mixer, or a batch mixer, for example, and then pumped via pumping equipment 134 to the wellbore 118. In some embodiments, the mixing equipment 132 and the pumping equipment 134 may be disposed on one or more cement trucks as should be apparent to those of ordinary skill in the art. While not shown separately, in embodiments, the mixing equipment 132 may comprise one or more of a circulating pump, a liquid additive system, an additive tank, and/or a storage tank.

The exemplary lost circulation compositions disclosed herein may directly or indirectly affect one or more components or pieces of equipment associated with the preparation, delivery, recapture, recycling, reuse, and/or disposal of the disclosed lost circulation compositions. For example, the disclosed lost circulation compositions may directly or indirectly affect one or more mixers, related mixing equipment, mud pits, storage facilities or units, composition separators, heat exchangers, sensors, gauges, pumps, compressors, and the like used generate, store, monitor, regulate, and/or recondition the exemplary lost circulation compositions. The disclosed lost circulation compositions may also directly or indirectly affect any transport or delivery equipment used to convey the lost circulation compositions to a well site or downhole such as, for example, any transport vessels, conduits, pipelines, trucks, tubulars, and/or pipes used to compositionally move the lost circulation compositions from one location to another, any pumps, compressors, or motors (e.g., topside or downhole) used to drive the lost circulation compositions into motion, any valves or related joints used to regulate the pressure or flow rate of the lost circulation compositions, and any sensors (i.e., pressure and temperature), gauges, and/or combinations thereof, and the like. The disclosed lost circulation compositions may also directly or indirectly affect the various downhole equipment and tools that may come into contact with the lost circulation compositions such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

Accordingly, the present disclosure may provide methods, systems, and apparatus that may relate to a phosphate ester lost circulation material. The methods, systems. and apparatus may include any of the various features disclosed herein, including one or more of the following statements.

Statement 1. A method for bridging a lost circulation zone comprising: providing a lost circulation composition comprising a phosphate ester based lost circulation material and a carrier fluid; introducing the lost circulation composition into a wellbore within a subterranean formation, wherein the subterranean formation comprises a lost circulation zone; and placing the lost circulation composition into the lost circulation zone.

Statement 2. The method of statement 1 wherein the phosphate ester based lost circulation material is a reaction product of a phosphate ester surfactant and a crosslinker.

Statement 3. The method of statement 2 wherein the phosphate ester surfactant comprises at least one of the following formulas:

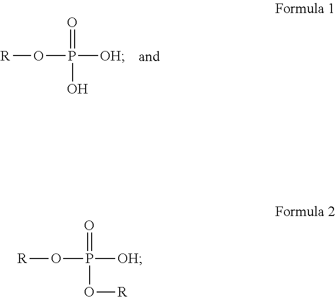

wherein R is individually selected from the group consisting of an alcohol, an ethoxylated alcohol, an ethoxylated phenol, and combinations thereof.

Statement 4. The method of any of statements 1-3 wherein the crosslinker is selected from the group consisting of ammonium iron(II) sulfate hexahydrate, iron(II) bromide, iron(III) bromide, iron(II) chloride, iron(II) chloride tetrahydrate, iron(III) chloride, iron(III) citrate, iron(II) fluoride, iron(III) fluoride, iron(III) fluoride trihydrate, iron(II) iodide, iron(III) nitrate nonahydrate, iron(II) oxalate dihydrate, iron(III) oxalate hexahydrate, iron(II) perchlorate hydrate, iron(III) phosphate tetrahydrate, iron(III) pyrophosphate, iron(II) sulfate, iron(II) sulfate hydrate, iron(II) tetrafluoroborate hexahydrate, potassium hexacyanoferrate(II) trihydrate, and combinations thereof.

Statement 5. The method of any of statements 1-4 wherein R has a carbon chain length from about C4 to about C20.

Statement 6. The method of any of statements 1-5 wherein the phosphate ester based lost circulation material is at least partially coated on graphitic carbon.

Statement 7. The method of any of statements 1-6 wherein the step of introducing the lost circulation composition into the wellbore comprises combining the lost circulation composition with an invert emulsion drilling fluid, the invert emulsion drilling fluid comprising a hydrocarbon external phase and aqueous internal phase.

Statement 8. The method of any of statements 1-7 further comprising contacting the lost circulation composition with a breaker and at least partially removing the lost circulation composition from the lost circulation zone.

Statement 9. A lost circulation composition comprising: a phosphate ester based lost circulation material; and a carrier fluid.

Statement 10. The composition of statement 9 wherein the phosphate ester based lost circulation material is a reaction product of a phosphate ester surfactant and a crosslinker.

Statement 11. The composition of any of statements 9-10 wherein the phosphate ester surfactant comprises at least one of the following formulas:

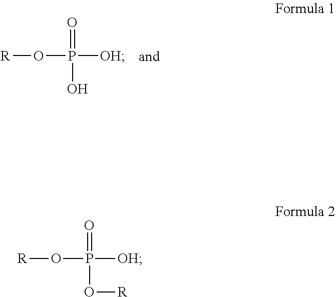

wherein R is individually selected from the group consisting of an alcohol, an ethoxylated alcohol, an ethoxylated phenol, and combinations thereof.

Statement 12. The composition of any of statements 9-11 wherein R has a carbon chain length from about C4 to about C20.

Statement 13. The composition of any of statements 9-12 wherein the crosslinker is selected from the group consisting of ammonium iron(II) sulfate hexahydrate, iron(II) bromide, iron(III) bromide, iron(II) chloride, iron(II) chloride tetrahydrate, iron(III) chloride, iron(III) citrate, iron(II) fluoride, iron(III) fluoride, iron(III) fluoride trihydrate, iron(II) iodide, iron(III) nitrate nonahydrate, iron(II) oxalate dihydrate, iron(III) oxalate hexahydrate, iron(II) perchlorate hydrate, iron(III) phosphate tetrahydrate, iron(III) pyrophosphate, iron(II) sulfate, iron(II) sulfate hydrate, iron(II) tetrafluoroborate hexahydrate, potassium hexacyanoferrate(II) trihydrate, and combinations thereof.

Statement 14. The composition of any of statements 9-13 wherein the carrier fluid is selected from the group consisting of petroleum oil, natural oil, synthetically derived oil, mineral oil, silicone oil, kerosene oil, diesel oil, an alpha olefin, an internal olefin, an ester, a diester of carbonic acid, a paraffin, and combinations thereof.

Statement 15. The composition of any of statements 9-14 wherein the carrier fluid is an invert emulsion comprising a hydrocarbon external phase and aqueous internal phase.

Statement 16. The composition of any of statements 9-15 further comprising graphitic carbon, wherein the phosphate ester based lost circulation material is at least partially coated on the graphitic carbon.

Statement 17. The composition of any of statements 9-16 further comprising at least one additional lost circulation material selected from the group consisting of cedar bark, shredded cane stalks, mineral fiber, mica flakes, cellophane, calcium carbonate, ground rubber, polymeric materials, pieces of plastic, ground marble, wood, nut hulls, plastic laminates, corncobs, cotton hulls, and combinations thereof.

Statement 18. A system for bridging a lost circulation zone comprising: a lost circulation composition comprising a phosphate ester based lost circulation material and a carrier fluid; mixing equipment capable of mixing the phosphate ester based lost circulation material and the carrier fluid; and pumping equipment capable of introducing the lost circulation composition into a lost circulation zone, wherein the pumping equipment is in fluid communication with the mixing equipment and a wellbore comprising the lost circulation zone.

Statement 19. The system of statement 18 wherein the phosphate ester surfactant comprises at least one of the following formulas:

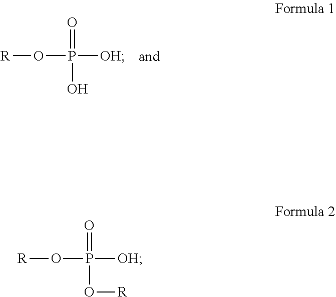

wherein R is individually selected from the group consisting of an alcohol, an ethoxylated alcohol, an ethoxylated phenol, and combinations thereof and wherein R has a carbon chain length from about C4 to about C20.

Statement 20. The system of any of statements 18-19 wherein the crosslinker is selected from the group consisting of ammonium iron(II) sulfate hexahydrate, iron(II) bromide, iron(III) bromide, iron(II) chloride, iron(II) chloride tetrahydrate, iron(III) chloride, iron(III) citrate, iron(II) fluoride, iron(III) fluoride, iron(III) fluoride trihydrate, iron(II) iodide, iron(III) nitrate nonahydrate, iron(II) oxalate dihydrate, iron(III) oxalate hexahydrate, iron(II) perchlorate hydrate, iron(III) phosphate tetrahydrate, iron(III) pyrophosphate, iron(II) sulfate, iron(II) sulfate hydrate, iron(II) tetrafluoroborate hexahydrate, potassium hexacyanoferrate(II) trihydrate, and combinations thereof.

To facilitate a better understanding of the present disclosure, the following examples of some specific embodiments are given. In no way should the following examples be read to limit, or to define, the scope of the disclosure.

### EXAMPLE 1

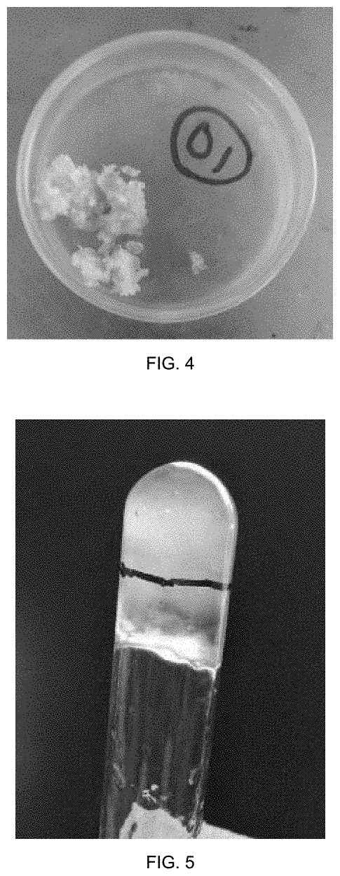

An oil swellable lost circulation material was prepared and tested. A 1:1 ratio of a surfactant and cross linker were placed in a beaker and mixed. The surfactant used comprised a phosphate ester surfactant which is the product of C6-C12 ethoxylated ester surfactant reacted with phosphoric acid. The crosslinker used is ferric sulfate in a solution of amines and polar oils. The reaction product of the surfactant and crosslinker was isolated from unreacted reactants by dispersing the reaction product in water and thereafter removing the water by placing the reaction products in an over at 100° C. for a period of 4 hours. The dried reaction product was observed to have a gel consistency. FIG. 4 is photograph of the dried reaction product. A sample of the dried reaction product was added to a test tube and a hydrocarbon oil was added to the test tube. It was observed that the reaction product swelled to about twice the initial volume and absorbed all the oil present. FIG. 5 is a photograph of the swelled reaction product.

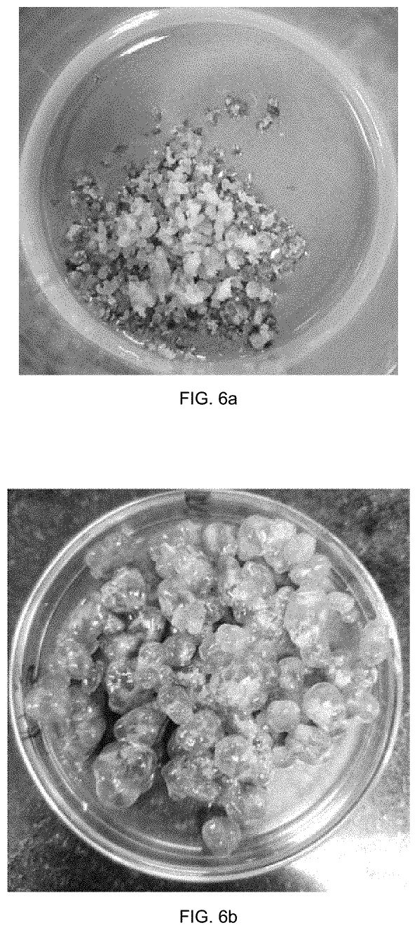

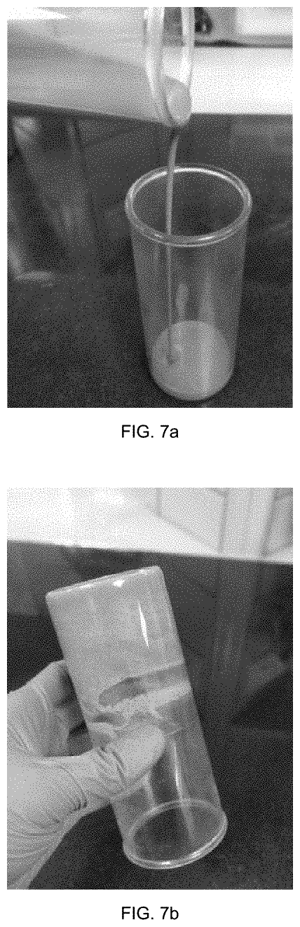

About 2 grams of the dried reaction product was dispersed in an oil-based drilling fluid and was kept undisturbed for a period of 24 hours at room temperature. FIG. 6a is a photograph of the dried reaction product prior to dispersion in the oil-based drilling fluid. It was observed that the dried reaction product swelled to 8 grams of total weight after the 24 hour period. FIG. 6b is a photograph of the dried reaction product after dispersion into the oil-based drilling fluid. Another test was performed by adding 5 mL each of the phosphate ester surfactant and ferric sulfate to 100 mL of the drilling fluid. FIG. 7a is a photograph of the drilling fluid containing the phosphate ester surfactant and ferric sulfate in the oil-based drilling fluid, illustrating that the drilling fluid is still pourable. It was observed that after 8 hours the resultant mixture had become extremely viscous and did not flow under gravitational shear. FIG. 7b is a photograph of the drilling fluid after 8 hours showing that the drilling fluid does not flow under gravitational shear.

### EXAMPLE 2

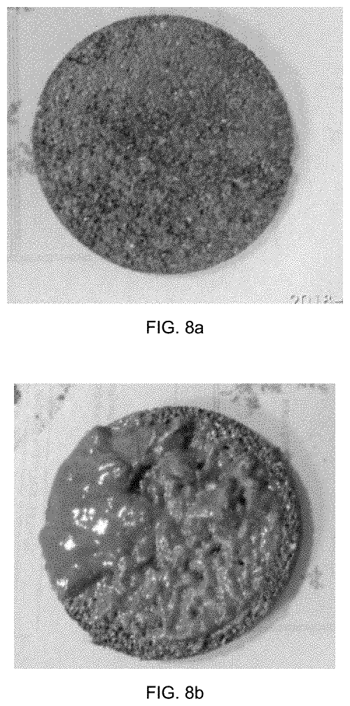

The following series of particle plugging tests were performed to test plugging properties of the disclosed lost circulation compositions. Two drilling fluids were prepared according to the compositions listed in Table 2. In Table 2, the amount of each species added is shown in pounds per barrel (ppb). The two drilling fluids were tested with a Permeability Plugging Apparatus (PPA) available from Fann® Instrument Company, Houston, Tex. in accordance with the API filtration test API described in Recommended Practice 13B-2, “Recommended Practice for Field Testing Oil Based Drilling Fluids.” The fluids were mixed to 12 ppg (pounds per gallon) (1437.92 kg/m³). The first fluid, corresponding to test 1, contained no surfactant and no cross-linker. The first fluid was subjected to a particle plugging test with a 120 micron disk at 500 psi (3447 kPa) differential pressure. No plugging was observed in the first fluid test. FIG. 8a is a photograph showing the results of the first particle plugging test. In the second fluid, corresponding to test 2, the surfactant and the crosslinker were added to the fluid immediately prior to the particle plugging test. It was observed that the second fluid exhibited gelling and plugging on the 120 micron disk at 500 psi (3447 kPa) differential pressure. FIG. 8b is a photograph of the results of the second particle plugging test.

TABLE 2

| Species (ppb) | Mix Time (min) | Test 1 | Test 2 |
|---|---|---|---|
| Base Oil | 5 | 151.48 | 151.48 |
| Emulsifier | | 12.25 | 12.25 |
| Lime | 5 | 3.15 | 3.15 |
| Filtration Control Agent | 10 | 2.8 | 2.8 |
| Water | 10 | 68.6 | 68.6 |
| Calcium Chloride | | 26.394 | 26.394 |
| Viscosifier 1 | 10 | 6.3 | 6.3 |
| Viscosifier 2 | 10 | 1.75 | 1.75 |
| Viscosifier 3 | 10 | 3.5 | 3.5 |
| Viscosifier 4 | 10 | 2.8 | 2.8 |
| Barite | 10 | 224.369 | 224.369 |
| Phosphate Ester Surfactant | | | 10 |
| Cross-Linker | | | 10 |

TABLE 3

| | | |
|---|---|---|
| Test Conditions | Test 1 | Test 2 |

| | | |
|---|---|---|
| Temperature | Room Temperature | Room Temperature |

| | | | | |
|---|---|---|---|---|
| Pressure | 500 | psi | 500 | psi |
| Ceramic disk size | 120 | micron | 120 | micron |

| | | |
|---|---|---|
| Plugging Observed | No | Yes |

### EXAMPLE 2

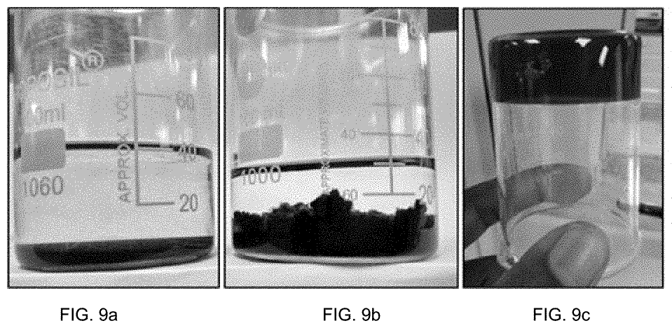

Resilient graphitic carbon and surfactant in a 1:1 ratio was added together and mixed in a glass beaker. Thereafter, crosslinker in a ratio of 1:1:0.4 was added to the graphitic carbon and surfactant composite and mixed vigorously. The resultant hybrid lost circulation material product was tested for swelling. A base oil was added to each of a breaker of unmodified graphitic carbon and a beaker of the hybrid lost circulation material. It was observed that the unmodified graphitic carbon did not swell in the base oil. After about 30 minutes, the hybrid lost circulation material had absorbed a portion of the base oil. After a prolonged period of time, it was observed that the base oil has been completely absorbed by the hybrid lost circulation material. FIG. 9a is a photograph showing the unmodified graphitic carbon in a beaker where the unmodified graphitic carbon shows no swelling. FIG. 9b is a photograph of the hybrid lost circulation material after 30 minutes showing swelling. FIG. 9c is a photograph of the hybrid lost circulation material after a prolonged period of time showing the oil completely absorbed by the hybrid lost circulation material.

### EXAMPLE 3

A drilling fluid was prepared according to Table 4. A permeability plugging test was performed with a permeability plugging apparatus. Three fluids were prepared for permeability plugging tests. A first test was performed with an unmodified drilling fluid, a second test was performed with drilling fluid with resilient graphitic carbon, and a third test was performed with drilling fluid with the hybrid lost circulation material product from Example 2.

TABLE 4

| Species (ppb) | Mix Time (min) | Test 3 |
|---|---|---|
| Base Oil | 5 | 151.48 |
| Emulsifier | | 12.25 |
| Lime | 5 | 3.15 |
| Filtration Control Agent | 10 | 2.8 |
| Water | 10 | 68.6 |
| Calcium Chloride | | 26.394 |
| Viscosifier 1 | 10 | 6.3 |
| Viscosifier 2 | 10 | 1.75 |
| Viscosifier 3 | 10 | 3.5 |
| Viscosifier 4 | 10 | 2.8 |
| Barite | 10 | 224.369 |

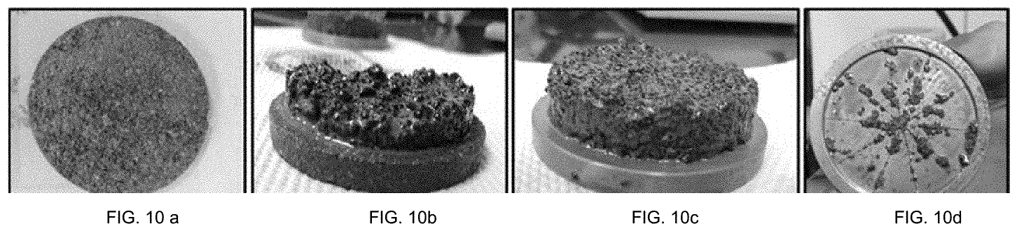

Each of the plugging tests was performed at room temperature with a 500 psi differential pressure. It was observed that in the first test with unmodified drilling fluid, no plugging on a 150 micron ceramic disk was observed. FIG. 10a is a photograph of the first test showing no plugging on the ceramic disk. In the second test with drilling fluid with resilient graphitic carbon, no plugging was observed on a 150 micron ceramic disk. In the third test with hybrid lost circulation material product, the fluid plugged both a 150 micron ceramic disk and a 200 micron slot disk. FIG. 10b is a photograph of the third particle plugging test on a 150 micron ceramic disk showing plugging. FIG. 10c is a photograph of the fourth particle plugging test on a 200 micron slot disk showing plugging. FIG. 10d is photograph of the rear of the 200 micron slot disk after the particle plugging test.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

It should be understood that the compositions and methods are described in terms of “comprising,” “containing,” or “including” various components or steps, the compositions and methods can also “consist essentially of” or “consist of” the various components and steps.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are discussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

What is claimed is:

1. A method for bridging a lost circulation zone comprising:
providing a lost circulation composition comprising a phosphate ester based lost circulation material and a carrier fluid;
introducing the lost circulation composition into a wellbore within a subterranean formation, wherein the subterranean formation comprises a lost circulation zone; and
placing the lost circulation composition into the lost circulation zone.

2. The method of claim 1 wherein the phosphate ester based lost circulation material is a reaction product of a phosphate ester surfactant and a crosslinker.

3. The method of claim 2 wherein the phosphate ester surfactant comprises at least one of the following formulas: 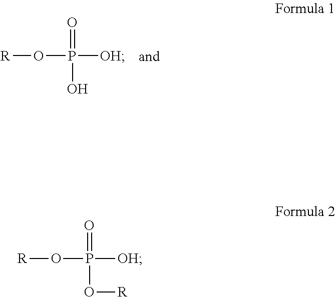
wherein R is individually selected from the group consisting of an alcohol, an ethoxylated alcohol, an ethoxylated phenol, and combinations thereof.

4. The method of claim 2 wherein the crosslinker is selected from the group consisting of ammonium iron(II) sulfate hexahydrate, iron(II) bromide, iron(III) bromide, iron(II) chloride, iron(II) chloride tetrahydrate, iron(III) chloride, iron(III) citrate, iron(II) fluoride, iron(III) fluoride, iron(III) fluoride trihydrate, iron(II) iodide, iron(III) nitrate nonahydrate, iron(II) oxalate dihydrate, iron(III) oxalate hexahydrate, iron(II) perchlorate hydrate, iron(III) phosphate tetrahydrate, iron(III) pyrophosphate, iron(II) sulfate, iron(II) sulfate hydrate, iron(II) tetrafluoroborate hexahydrate, potassium hexacyanoferrate(II) trihydrate, and combinations thereof.

5. The method of claim 2 wherein R has a carbon chain length from about C4 to about C20.

6. The method of claim 2 wherein the phosphate ester based lost circulation material is at least partially coated on graphitic carbon.

7. The method of claim 2 wherein the step of introducing the lost circulation composition into the wellbore comprises combining the lost circulation composition with an invert emulsion drilling fluid, the invert emulsion drilling fluid comprising a hydrocarbon external phase and aqueous internal phase.

8. The method of claim 2 further comprising contacting the lost circulation composition with a breaker and at least partially removing the lost circulation composition from the lost circulation zone.

9. A lost circulation composition comprising:
a phosphate ester based lost circulation material; and
a carrier fluid.

10. The composition of claim 9 wherein the phosphate ester based lost circulation material is a reaction product of a phosphate ester surfactant and a crosslinker.

11. The composition of claim 10 wherein the phosphate ester surfactant comprises at least one of the following formulas: 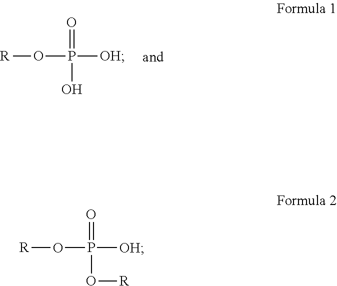
wherein R is individually selected from the group consisting of an alcohol, an ethoxylated alcohol, an ethoxylated phenol, and combinations thereof.

12. The composition of claim 11 wherein R has a carbon chain length from about C4 to about C20.

13. The composition of claim 10 wherein the crosslinker is selected from the group consisting of ammonium iron(II) sulfate hexahydrate, iron(II) bromide, iron(III) bromide, iron(II) chloride, iron(II) chloride tetrahydrate, iron(III) chloride, iron(III) citrate, iron(II) fluoride, iron(III) fluoride, iron(III) fluoride trihydrate, iron(II) iodide, iron(III) nitrate nonahydrate, iron(II) oxalate dihydrate, iron(III) oxalate hexahydrate, iron(II) perchlorate hydrate, iron(III) phosphate tetrahydrate, iron(III) pyrophosphate, iron(II) sulfate, iron(II) sulfate hydrate, iron(II) tetrafluoroborate hexahydrate, potassium hexacyanoferrate(II) trihydrate, and combinations thereof.

14. The composition of claim 9 wherein the carrier fluid is selected from the group consisting of petroleum oil, natural oil, synthetically derived oil, mineral oil, silicone oil, kerosene oil, diesel oil, an alpha olefin, an internal olefin, an ester, a diester of carbonic acid, a paraffin, and combinations thereof.

15. The composition of claim 9 wherein the carrier fluid is an invert emulsion comprising a hydrocarbon external phase and aqueous internal phase.

16. The composition of claim 9 further comprising graphitic carbon, wherein the phosphate ester based lost circulation material is at least partially coated on the graphitic carbon.

17. The composition of claim 9 further comprising at least one additional lost circulation material selected from the group consisting of cedar bark, shredded cane stalks, mineral fiber, mica flakes, cellophane, calcium carbonate, ground rubber, polymeric materials, pieces of plastic, ground marble, wood, nut hulls, plastic laminates, corncobs, cotton hulls, and combinations thereof.

18. A system for bridging a lost circulation zone comprising:
a lost circulation composition comprising a phosphate ester based lost circulation material and a carrier fluid;
mixing equipment capable of mixing the phosphate ester based lost circulation material and the carrier fluid; and
pumping equipment capable of introducing the lost circulation composition into a lost circulation zone, wherein the pumping equipment is in fluid communication with the mixing equipment and a wellbore comprising the lost circulation zone.

19. The system of claim 18 wherein the phosphate ester surfactant comprises at least one of the following formulas: 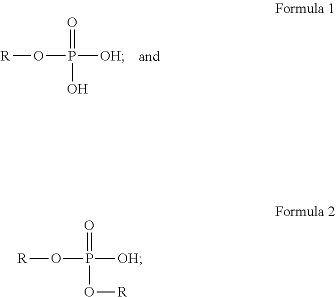
wherein R is individually selected from the group consisting of an alcohol, an ethoxylated alcohol, an ethoxylated phenol, and combinations thereof and wherein R has a carbon chain length from about C4 to about C20.

20. The system of claim 18 wherein the crosslinker is selected from the group consisting of ammonium iron(II) sulfate hexahydrate, iron(II) bromide, iron(III) bromide, iron(II) chloride, iron(II) chloride tetrahydrate, iron(III) chloride, iron(III) citrate, iron(II) fluoride, iron(III) fluoride, iron(III) fluoride trihydrate, iron(II) iodide, iron(III) nitrate nonahydrate, iron(II) oxalate dihydrate, iron(III) oxalate hexahydrate, iron(II) perchlorate hydrate, iron(III) phosphate tetrahydrate, iron(III) pyrophosphate, iron(II) sulfate, iron(II) sulfate hydrate, iron(II) tetrafluoroborate hexahydrate, potassium hexacyanoferrate(II) trihydrate, and combinations thereof.
